(19) United States
(12) Patent Application Publication
(10) Pub. No.: US 2020/0013085 A1
(43) Pub. Date: Jan. 9, 2020

(54) SERVICE DEVICE AND METHOD OF OPERATING SAME

(71) Applicant: SK PLANET CO., LTD., Gyeonggi-do (KR)

(72) Inventor: Ki Chon KANG, Seoul (KR)

(73) Assignee: SK PLANET CO., LTD.

(21) Appl. No.: 16/502,364

(22) Filed: Jul. 3, 2019

(30) Foreign Application Priority Data
Jul. 6, 2018 (KR) 10-2018-0078980

(51) Int. Cl. G06Q 30/02; H04L 29/08; G06T 7/33

(52) U.S. Cl. CPC G06Q 30/0255; G06T 7/337; H04L 67/18

(57) ABSTRACT

Disclosed are a service device and a method of operating the same which can analyze state information of a subscriber based on a photographing image and provide an advertisement on the basis of the analyzed state information to the subscriber, thereby providing a targeted advertisement reflecting a real-time state of the subscriber, so as to increase an advertisement effect.

### CROSS-REFERENCE TO RELATED APPLICATIONS

This application is based upon and claims the benefit of priority from Korean Patent Application No. 10-2018-0078980, filed on Jul. 6, 2018, the entire contents of which are incorporated herein by reference.

### BACKGROUND OF THE INVENTION

### 1. Field of the Invention

The present disclosure relates to a technology for providing an advertisement based on a real-time state of a subscriber that is analyzed based on a photographed image.

### 2. Description of the Prior Art

As the market of applications that are executed by mobile devices such as smart phones, tablet pads, and the like rapidly expands, an advertisement market related thereto is expanding at a high speed.

When executing an application or accessing a service page (for example, a webpage) which corresponds to an advertisement medium, the mobile device (hereinafter, referred to as a “subscriber terminal”) may receive an advertisement provided from an advertisement providing device and display the advertisement on an execution screen of the application or an access screen of the service page.

Further, when a displayed advertisement is clicked (selected), the subscriber terminal may access an advertiser page linked to the advertisement.

Meanwhile, the advertisement providing device generally adopts an advertisement targeting scheme that selects and provides an advertisement suitable for a user to increase an advertisement effect.

The advertisement targeting scheme can be a segmentation scheme of classifying advertisement receiver groups according to a segment indicating group attributes of the advertisement receiver groups and providing an advertisement designated to each segment to users within the classified advertisement receiver groups.

However, the segmentation scheme may have a limit in that a real-time state of the advertisement receiver cannot be actively reflected since the advertisement is provided according to fixed group attributes

Such a limit may cause an advertisement targeting error, which makes an advertisement receiver to receive an advertisement the advertisement receiver is not interested in and an advertiser have an advertisement cost loss due to non-achievement of advertisement effects.

Accordingly, the present disclosure proposes a new advertisement targeting scheme capable of reflecting a real-time state of an advertisement receiver.

### SUMMARY OF THE INVENTION

The present disclosure has been made in order to solve the above-mentioned problems in the prior art and an aspect of the present disclosure is to provide an advertisement based on a real-time state of a subscriber analyzed from a photographing image.

In accordance with an aspect of the present disclosure, a service device is provided. The service device includes: a processor configured to perform calculations for providing an advertisement; and a memory configured to store at least one command executed through the processor, wherein the at least one command includes: an identification command of identifying a subscriber located in a subscriber analysis area based on location information of a subscriber terminal; and an analysis command of analyzing state information of the subscriber based on a photographing image obtained by photographing the subscriber analysis area and providing an advertisement according to the analyzed state information to the subscriber.

Specifically, the at least one command may further include a designation command of analyzing other subscriber who approaches the subscriber within a threshold distance based on the photographing image, designating the subscriber and the other subscriber as a state-based advertisement group when it is determined that there is a correlation between the subscriber and the other subscriber, and providing an identical advertisement on the basis of state information of at least one of the subscriber and the other subscriber to the subscriber within the state-based advertisement group.

Specifically, the at least one command may further include a designation command of analyzing other subscriber who approaches the subscriber within a threshold distance based on the photographing image, designating the subscriber and the other subscriber as a location-based advertisement group when it is determined that there is no correlation between the subscriber and the other subscriber, and providing an identical advertisement on the basis of the location to the subscriber within the location-based advertisement group.

Specifically, when the other subscriber is identified from a registration image which the subscriber registers or the subscriber is identified from a registration image which the other subscriber registers, the designation command may include determining that there is a correlation between the subscriber and the other subscriber.

Specifically, the analysis command may include identifying a particular object having similarity with a reference object image for recognizing the subscriber from objects within the photographing image and analyzing state information of the particular object as the state information of the subscriber, the similarity being larger than or equal to a threshold value.

Specifically, the reference object image may be learned from a registration image pre-registered in connection with the subscriber and the registration image may include an image uploaded to a particular Social Network Service (SNS) of the subscriber.

In accordance with another aspect of the present disclosure, a method of operating a service device is provided. The method includes: an identification step of identifying a subscriber located in a subscriber analysis area based on location information of a subscriber terminal; and an analysis step of analyzing state information of the subscriber based on a photographing image obtained by photographing the subscriber analysis area and providing an advertisement according to the analyzed state information to the subscriber.

Specifically, the method may further include a designation step of analyzing other subscriber who approaches the subscriber within a threshold distance based on the photographing image, designating the subscriber and the other subscriber as a state-based advertisement group when it is determined that there is a correlation between the subscriber and the other subscriber, and providing an identical advertisement on the basis of state information of at least one of the subscriber and the other subscriber to the subscriber within the state-based advertisement group.

Specifically, the at least one command may further include a designation step of analyzing other subscriber who approaches the subscriber within a threshold distance based on the photographing image, designating the subscriber and the other subscriber as a location-based advertisement group when it is determined that there is no correlation between the subscriber and the other subscriber, and providing an identical advertisement on the basis of the location to the subscriber within the location-based advertisement group.

Specifically, the designation step may include, when the other subscriber is identified from a registration image which the subscriber registers or the subscriber is identified from a registration image which the other subscriber registers, determining that there is a correlation between the subscriber and the other subscriber.

Specifically, the analysis step may include identifying a particular object having similarity with a reference object image for recognizing the subscriber from objects within the photographing image and analyzing state information of the particular object as the state information of the subscriber, the similarity being larger than or equal to a threshold value.

Specifically, the reference object image may be learned from a registration image pre-registered in connection with the subscriber and the registration image may include an image uploaded to a particular Social Network Service (SNS) of the subscriber.

According to a service device and a method of operating the same according to an embodiment of the present disclosure, it is possible to analyze state information of a subscriber based on a photographing image and provide an advertisement on the basis of the analyzed state information to the subscriber, thereby providing a targeted advertisement reflecting a real-time state of the subscriber, so as to increase an advertisement effect.

### BRIEF DESCRIPTION OF THE DRAWINGS

The above and other aspects, features and advantages of the present disclosure will be more apparent from the following detailed description taken in conjunction with the accompanying drawings, in which:

FIG. 1 illustrates a schematic configuration of a targeted advertisement system according to an embodiment of the present disclosure;

FIG. 2 illustrates a schematic configuration of a subscriber terminal according to an embodiment of the present disclosure;

FIG. 3 illustrates a hardware system for implementing the subscriber terminal according to an embodiment of the present disclosure;

FIG. 4 illustrates a schematic configuration of a service device according to an embodiment of the present disclosure;

FIG. 5 illustrates a hardware system for implementing the service device according to an embodiment of the present disclosure;

FIG. 6 is a flowchart schematically illustrating an operation flow in the targeted advertisement system according to an embodiment of the present disclosure;

FIG. 7 is a flowchart schematically illustrating an operation flow in the subscriber terminal according to an embodiment of the present disclosure; and

FIG. 8 is a flowchart schematically illustrating an operation flow in the service device according to an embodiment of the present disclosure.

### DETAILED DESCRIPTION OF THE EXEMPLARY EMBODIMENTS

It should be noted that the technical terms in the specification are merely used for describing a specific embodiment but do not limit the scope of the present disclosure. Further, the technical terms in the specification should be construed as a meaning generally understood by those skilled in the art unless the terms are defined as another meaning and should not be construed as an excessively inclusive meaning or an excessively exclusive meaning. When a technical term used in the specification is an incorrect technical term which does not accurately express the idea of the present disclosure, the technical term should be replaced with the correct technical term which can be understood by those skilled in the art. Further, the general terms used in the present disclosure should be interpreted in the context according to the dictionary definition and should not be construed as possessing an excessively limited meaning.

Hereinafter, exemplary embodiments of the present disclosure will be described in detail with reference to the accompanying drawings, equal or similar elements are assigned an equal reference numeral, and an overlapping description thereof will be omitted. Further, in the following description of the present disclosure, a detailed description of known technologies incorporated herein will be omitted when it may make the subject matter of the present disclosure rather unclear. Further, it should be noted that the accompanying drawings are intended only for the easy understanding of the technical idea of the present disclosure, and the spirit of the present disclosure should not be construed as being limited by the accompanying drawings. In addition to the accompanying drawings, the spirit of the present disclosure should be construed to cover all modifications, equivalents, and alternatives thereof.

Hereinafter, an embodiment of the present disclosure will be described with reference to the accompanying drawings.

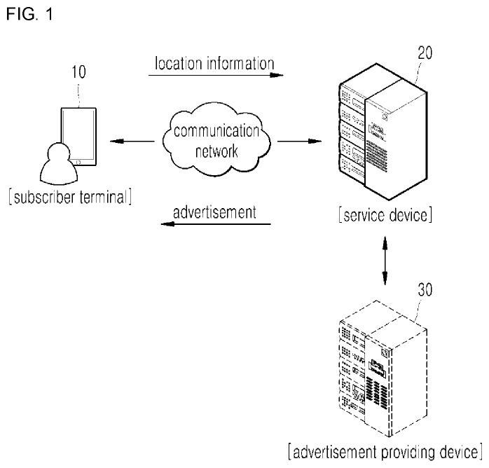

FIG. 1 illustrates a targeted advertisement system according to an embodiment of the present disclosure.

As illustrated in FIG. 1, the targeted advertisement system according to an embodiment of the present disclosure may include a subscriber terminal 10 configured to receive an advertisement and a service device 20 configured to provide an advertisement to the subscriber terminal 10.

Meanwhile, the targeted advertisement system according to an embodiment of the present disclosure may further include an advertisement providing device 30 which is a separate platform configured to provide an advertisement that is registered by an advertiser according to a request from the service device 20 to the subscriber terminal 10 according to an implementation type.

The subscriber terminal 10 is a subscriber terminal having an application installed therein to receive a service provided from the service device 20 separately from advertisement reception and may provide its own location information to the service device 20 based on the installed application.

Further, the subscriber terminal 10 may receive an advertisement through an advertisement medium and perform a series of operations such as access to an advertiser page when the advertisement is selected (clicked).

For example, the subscriber terminal 10 may correspond to a smart phone, a portable terminal, a mobile terminal, a Personal Digital Assistant (PDA), a Portable Multimedia Player (PMP) terminal, a telematics terminal, a navigation terminal, a Personal Computer (PC), a notebook computer, a slate PC, a tablet PC, an Ultrabook, a wearable device (for example, a watch-type terminal (smart watch), a glass-type terminal (smart glass), or a Head-Mounted Display (HMD)), a Wibro terminal, an Internet Protocol Television (IPTV) terminal, a smart TV, a digital broadcast terminal, a television, a 3D television, a home theater system, an Audio Video Navigation (AVN) terminal, an Audio/Video (NV) system, or a flexible terminal, but the present disclosure is not limited thereto and may include any device which can receive an advertisement through an advertisement medium.

The advertisement medium through which the subscriber terminal 10 can receive an advertisement may correspond to an application installed to receive a service from the service device 20.

The advertisement medium includes a Software Development Kit (SDK) related to the advertisement reception in a development process and, as a result, the subscriber terminal 10 may perform a series of operations for receiving and displaying the advertisement through the SDK included in the advertisement medium.

The service device 20 is a device that selects a targeted advertisement for a subscriber who possesses the subscriber terminal 10 and provides the selected targeted advertisement to the subscriber terminal 10 and may provide various services associated with the application installed in the subscriber terminal 10 as well as providing an advertisement.

The service device 20 may be implemented in the form of, for example, a web server, a database server, or a proxy server, or may be implemented as a computerized system through installation of one or more of various pieces of software that allow a network load distribution mechanism or the service device to operate over the Internet or another network.

Further, the network may be an http network, a private line, an intranet, or another network, and a connection between elements in the network may be made through a secure network to prevent data from being compromised by an arbitrary hacker or another third party.

The targeted advertisement system according to an embodiment of the present disclosure may provide a targeted advertisement to a subscriber who possesses the subscriber terminal 10 through the above-described configuration.

Meanwhile, as described in the prior art in connection with this, a representative scheme of the conventional advertisement targeting scheme is a segmentation scheme of classifying advertisement receiver groups according to a segment indicating group attributes of the advertisement receiver groups and providing an advertisement designated to each segment to users within the classified advertisement receiver groups.

However, the segmentation scheme may have a limit in that a real-time state of the advertisement receiver cannot be actively reflected since the advertisement is provided according to fixed group attributes

Such a limit may cause an advertisement targeting error, which makes an advertisement receiver to receive an advertisement that the advertisement receiver is not interested in and an advertiser have an advertisement cost loss due to non-achievement of advertisement effects.

Accordingly, an embodiment of the present disclosure proposes an advertisement targeting scheme that can actively reflect a real-time state of the subscriber and, hereinafter, the configuration of the service device 20 for implementing the advertisement targeting scheme will be described in more detail.

Meanwhile, for helping in understanding of description, the configuration of the subscriber terminal 10 will be described prior to the description of the service device 20.

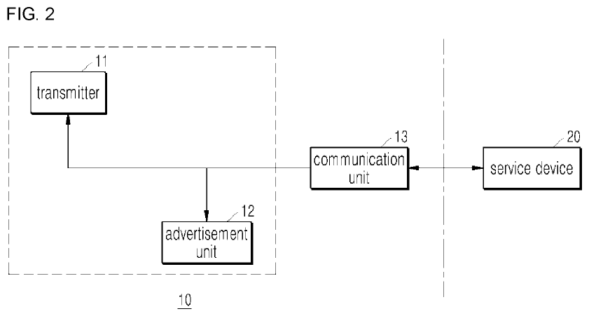

FIG. 2 illustrates the configuration of the subscriber terminal 10 according to an embodiment of the present disclosure.

As illustrated in FIG. 2, the subscriber terminal 10 according to an embodiment of the present disclosure may include a transmitter 11 configured to transmit location information and an advertisement unit 12 configured to receive an advertisement.

Particularly, the advertisement unit 12 is an element configured to perform a series of operations related to an advertisement when an application within the subscriber terminal 10 is executed, and may be understood as a Software Development Kit (SDK) embedded into the application.

All or at least some of the configuration of the subscriber terminal 10 including the transmitter 11 and the advertisement unit 12 may be implemented in the form of a software module (application) or a hardware module executed by the process or a combination of the software module and the hardware module.

Meanwhile, the subscriber terminal 10 according to an embodiment of the present disclosure may further include a communication unit 13 configured to serve an RF function for actual communication with the service device 20 as well as the above-described elements.

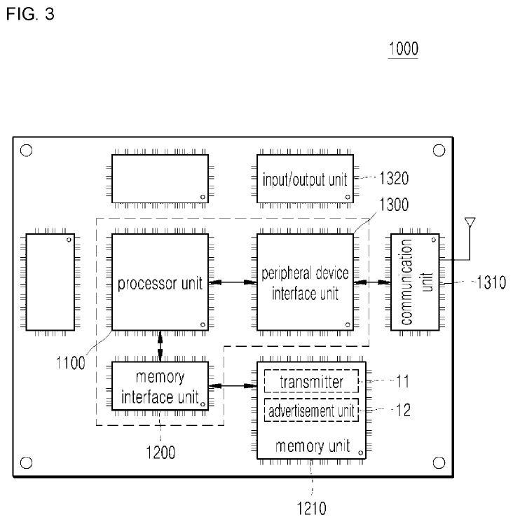

For reference, the element such as the communication unit 13 is an element corresponding to a communication unit 1310 described with reference to FIG. 3, and a detailed description thereof will be made below.

As a result, the subscriber terminal 10 according to an embodiment of the present disclosure may receive a vehicle sharing service from the service device 20 based on the above-described configuration and, hereinafter, elements within the subscriber terminal 10 for implementing the vehicle sharing service will be described in more detail.

The transmitter 11 performs a function of transmitting location information.

More specifically, the transmitter 11 acquires location information of the subscriber terminal 10 and transfers the acquired location information to the service device 20.

At this time, the transmitter 11 may acquire location information according to a period configured in an application or a request from the service device 20 and transmit the location information to the service device 20.

Here, the location information may include, for example, AP access information and GPS information, and may be transferred to the service device 20 together with visual information of the acquired location information while matching identification information (a subscriber ID) of the subscriber terminal 10.

The advertisement unit 12 performs a function of receiving an advertisement.

More specifically, the advertisement unit 12 receives an advertisement targeted at the subscriber from the service device 20 based on the location information of the subscriber terminal 10.

In connection with this, the service device 20 may identify the subscriber located in a predefined subscriber analysis area based on the location information received from the subscriber terminal 10, analyze a state information of the subscriber based on a photographing image which is obtained by photographing the subscriber analysis area, and provide an advertisement on the basis of the analyzed state information to the subscriber terminal 10.

In connection with this, a case in which an advertisement about an umbrella store closest to the subscriber in the subscriber analysis area is provided when it is identified that the subscriber does not have an umbrella based on the state information of the subscriber analyzed from the photographing image and when it is raining is provided as an example.

The subscriber analysis area is a heavily populated area and corresponds to an area in which a photographing image (for example, a video or a photo) obtained by photographing the corresponding area through a photographing device such as a CCTV can be always acquired.

Further, the state information may include information on a precise location of the subscriber within the subscriber analysis area, and clothes and belongings of the subscriber but is not limited thereto and may include any general information which can be acquired from the image according to a known image analysis technology.

That is, when it is identified that the subscriber is positioned in the subscriber analysis area based on the location information of the subscriber terminal 10, the service device 20 may acquire a photographing image from the corresponding subscriber analysis area and analyze the state information of the subscriber by analyzing the acquired photographing image.

The state information of the subscriber may be analyzed through the known image analysis technology as described above, but, in an embodiment of the present disclosure, state information of a particular object having similarity with a reference object image for recognizing the subscriber among objects within the photographing image is basically analyzed as the state information of the subscriber, the similarity being larger than or equal to a threshold value.

In order to analyze the state information of the subscriber, it is required to prepare the reference object image to be compared with the object within the photographing image, and the reference object image may be learned from a registration image pre-registered in connection with the subscriber.

The registration image may be understood as, for example, an image (for example, a moving image or a photo) uploaded to a subscriber's account in a specific Social Network Service (SNS) associated with the service device 20, but is not limited thereto and may also include an image which the subscriber directly registers in the service device 20.

Meanwhile, it is assumed that another subscriber who approaches the subscriber within a threshold distance is analyzed from the photographing image obtained by photographing the subscriber analysis area in an embodiment of the present disclosure.

In this case, the service device 20 may determine whether there is a correlation between the subscriber and the other subscriber and may classify the subscriber and the other subscriber into state-based advertisement groups or location-based advertisement groups according to the determination result.

Specifically, the service device 20 may analyze another subscriber who approaches the subscriber within a threshold distance from the photographing image obtained by photographing the subscriber analysis area and, when it is determined that there is a correlation between the subscriber and the other subscriber, designate the subscriber and the other subscriber as the state-based advertisement group.

As there is a correlation between the subscriber and the other subscriber, the state-based advertisement group may be considered as a group of which members have a common interest, and the same advertisement on the basis of the state information of the subscriber or the other subscriber may be provided to the state-based advertisement group.

On the other hand, the service device 20 may analyze another subscriber who approaches the subscriber within a threshold distance from the photographing image obtained by photographing the subscriber analysis area and, when it is determined that there is no correlation between the subscriber and the other subscriber, designate the subscriber and the other subscriber as the location-based advertisement group.

As there is a correlation between the subscriber and the other subscriber, the location-based advertisement group may be considered as a group of which members have no common interest, and the same location-based advertisement on the basis of an adjacency characteristic that is a common denominator may be provided to the location-based advertisement group.

Meanwhile, when another subscriber adjacent to the subscriber is identified from the registration image which the subscriber registers or, reversely, the subscriber is identified from the registration image which the other subscriber registers in connection with designation of the advertisement group, the service device 20 may determine that there is a correlation between the subscriber and the other subscriber.

The correlation can be determined in the form of a value according to a level of the correlation on the basis of an appearance frequency within the registration image as well as simply having a correlation.

Meanwhile, each element within the subscriber terminal 10 may be implemented in the form of a software module or a hardware module executed by the process or a combination of the software module and the hardware module.

As described above, the software module and the hardware module executed by the processor, and the combination of the software module and the hardware module may be implemented by a hardware system (for example, a computer system).

Accordingly, hereinafter, a hardware system 1000 in which the subscriber terminal 10 according to an embodiment of the present disclosure is implemented in the form of hardware will be described with reference to FIG. 3.

For reference, the following description is an example of the hardware system 1000 in which each element within the subscriber terminal 10 is implemented, and it should be noted that each element and the operation thereof may be different from those of an actual system.

As illustrated in FIG. 3, the hardware system 1000 according to an embodiment of the present disclosure may include a processor unit 1100, a memory interface unit 1200, and a peripheral device interface unit 1300.

The respective elements within the hardware system 1000 may be individual elements or integrated into one or more integrated circuits, and may be combined by a bus system (not shown).

The bus system corresponds to abstraction indicating one or more individual physical buses, communication lines/interfaces, multi-drop, and/or point-to-point connections connected by proper bridges, adaptors, and/or controllers.

The processor unit 1100 may serve to execute various software modules stored in the memory unit 1210 by communicating with the memory unit 1210 through the memory interface unit 1200 in order to perform various functions in the hardware system.

The memory unit 1210 may store the transmitter 11 and the advertisement unit 12, which are the elements within the subscriber terminal 10 described with reference to FIG. 2, in the software module form, and may further store an Operating System (OS).

The operating system (for example, an embedded operating system such as iOS, Android, Darwin, RTXC, LINUX, UNIX, OSX, WINDOWS, or VxWorks) includes various procedures for controlling and managing general system tasks (for example, memory management, storage device control, and power management), an instruction set, a software component, and/or a driver, and serves to make communication between various hardware modules and software modules easy.

For reference, the memory unit 1210 includes a cache, a main memory, and a secondary memory but is not limited thereto, and may include a memory layer structure. The memory layer structure may be implemented through a predetermined combination of, for example, a RAM (for example, SRAM, DRAM, or DDRAM), a ROM, a FLASH, a magnetic and/or optical storage device (for example, a disk drive, a magnetic tape, a Compact Disk (CD), and a Digital Video Disc (DVD)).

The peripheral interface unit 1300 serves to enable communication between the processor unit 1100 and peripheral devices.

The peripheral device may provide different functions to the hardware system 1000 and may include, for example, a communication unit 1310 and an input/output unit 1320 according to an embodiment of the present disclosure.

The communication unit 1310 serves to provide a communication function with another device. To this end, the communication unit 1310 may include, for example, an antenna system, an RF transceiver, one or more amplifiers, a tuner, one or more oscillators, a digital signal processor, a CODEC chipset, and a memory, but is not limited thereto, and may include a known circuit for performing the function.

Communication protocols supported by the communication unit 1310 may include, for example, Wireless LAN (WLAN), Digital Living Network Alliance (DLNA), Wireless broadband (Wibro), World interoperability for microwave access (Wimax), Global System for Mobile communication (GSM), Code Division Multi Access (CDMA), Code Division Multi Access 2000 (CDMA2000), Enhanced Voice-Data Optimized or Enhanced Voice-Data Only (EV-DO), Wideband CDMA (WCDMA), High Speed Downlink Packet Access (HSDPA), High Speed Uplink Packet Access (HSUPA), IEEE 802.16, Long Term Evolution (LTE), Long Term Evolution-Advanced (LTE-A), Wireless Mobile Broadband Service (WMBS), Bluetooth, Radio Frequency Identification (RFID), Infrared Data Association (IrDA), Ultra-Wideband (UWB), ZigBee, Near Field Communication (NFC), Ultra Sound Communication (USC), Visible Light Communication (VLC), Wi-Fi, and Wi-Fi Direct. Wired communication networks may include wired Local Area Network (LAN), wired Wide Area Network (WAN), Power Line Communication (PLC), USB communication, Ethernet, serial communication, and optical fiber/coaxial cable, but are not limited thereto and may include nay protocol that can provide a communication environment with another device.

Further, the input/output unit 1320 may serve as a controller configured to control an I/O device interworking with other hardware systems and may serve to control a GPS for acquiring location information of the subscriber terminal 10 and a display for an interface with the subscriber in an advertisement exposure process according to an embodiment of the present disclosure.

As a result, each element within the subscriber terminal 10 stored in the memory unit 1210 of the hardware system 1000 according to an embodiment of the present disclosure in the form of a software module may execute an interface with the communication unit 1310 and the input/output unit 1320 via the memory interface unit 1200 and the peripheral device interface unit 1300 in the form of instructions executed by the processor unit 1100, thereby receiving an advertisement which reflects the state information of the subscriber from the service device 20.

The description of the configuration of the subscriber terminal 10 according to an embodiment of the present disclosure has been completed and the description of the configuration of the service device 20 will be subsequently made.

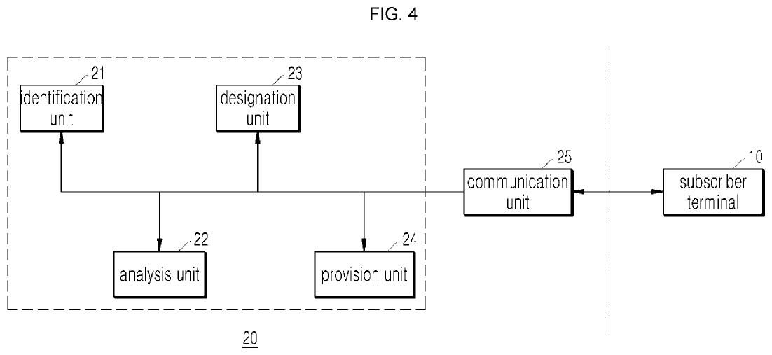

FIG. 4 illustrates a schematic configuration of the service device 20 according to an embodiment of the present disclosure.

As illustrated in FIG. 4, the service device 20 according to an embodiment of the present disclosure may include an identification unit 21 configured to identify a subscriber and an analysis unit 22 configured to analyze state information of the subscriber from a photographing image.

Further, the service device 20 according to an embodiment of the present disclosure may further include a designation unit 23 configured to designate an advertisement group and a provision unit 24 configured to provide an advertisement as well as the above-described elements.

All or at least some of the elements of the service device 20 including the identification unit 21, the analysis unit 22, the designation unit 23, and the provision unit 24 may be implemented in the form of a software module or a hardware module executed by the processor or a combination of the software module and the hardware module.

The software module may be understood as, for example, instructions executed by the processor that controls calculations within the service device 20, and the instructions may have the form of being installed in a memory within the service device 20.

Meanwhile, the service device 20 according to an embodiment of the present disclosure may further include a communication unit 25, which is an RF module configured to serve actual communication with the subscriber terminal 10 as well as the above-described elements.

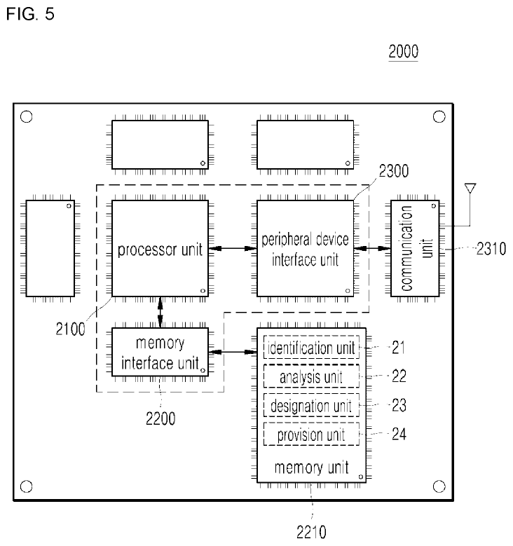

For reference, the element such as the communication unit 25 is an element corresponding to a communication unit 2310 described with reference to FIG. 5, and a detailed description thereof will be made below

As a result, the service device 20 according to an embodiment of the present disclosure may authenticate a user through an authentication scheme differently determined according to space reliability decided based on an authentication processing space through the above-described configuration and, hereinafter, each element within the service device 20 for implementing the authentication will be described in more detail.

The identification unit 21 performs a function of identifying a subscriber.

More specifically, the identification unit 21 identifies a subscriber located in a predefined subscriber analysis area based on location information received from the subscriber terminal 10.

The subscriber analysis area is a heavily populated area and corresponds to an area in which a photographing image (for example, a video or a photo) obtained by photographing the corresponding area through a photographing device such as a CCTV can be always acquired.

The analysis unit 22 performs a function of analyzing state information of the subscriber.

More specifically, when the subscriber located in the subscriber analysis area is identified, the identification unit 22 may analyze state information of the subscriber from a photographing image obtained by photographing the subscriber analysis area and allow the provision unit 24 to provide an advertisement selected based on the analyzed state information of the subscriber to the subscriber terminal 10.

In connection with this, a case in which an advertisement about an umbrella store closest to the subscriber in the subscriber analysis area is provided when it is identified that the subscriber does not have an umbrella based on the state information of the subscriber analyzed from the photographing image and when it is raining is provided as an example.

In other words, when it is identified that the subscriber is located in the subscriber analysis area from the location information of the subscriber terminal 10, the analysis unit 22 may acquire the photographing image from the corresponding subscriber analysis area and analyze the state information of the subscriber by analyzing the acquired photographing image.

The state information of the subscriber may include information on a precise location of the subscriber within the subscriber analysis area, and clothes and belongings of the subscriber but is not limited thereto and may include any general information which can be acquired from the image according to a known image analysis technology.

The state information of the subscriber may be analyzed through the known image analysis technology as described above, but, in an embodiment of the present disclosure, state information of a particular object having similarity with a reference object image for recognizing the subscriber among objects within the photographing image is basically analyzed as the state information of the subscriber, the similarity being larger than or equal to a threshold value.

In order to analyze the state information of the subscriber, it is required to prepare the reference object image to be compared with the object within the photographing image, and the reference object image may be learned from a registration image pre-registered in connection with the subscriber.

The registration image may be understood as, for example, an image (for example, a moving image or a photo) uploaded to a subscriber's account in a specific Social Network Service (SNS) associated with the service device 20, but is not limited thereto and may also include an image which the subscriber directly registers in the service device 20.

The designation unit 23 performs a function of designating an advertisement group.

More specifically, when another subscriber who approaches the subscriber within a threshold distance is analyzed from the photographing image obtained by photographing the subscriber analysis area, the designation unit 23 may designate the subscriber and the other subscriber as an advertisement group.

At this time, the designation unit 23 may determine whether there is a correlation between the subscriber and the other subscriber prior to designation of the advertisement group and may classify the subscriber and the other subscriber as a state-based advertisement group or a location-based advertisement group according to the determination result.

That is, the designation unit 23 may analyze another subscriber who approaches the subscriber within a threshold distance from the photographing image obtained by photographing the subscriber analysis area and, when it is determined that there is a correlation between the subscriber and the other subscriber, designate the subscriber and the other subscriber as the state-based advertisement group.

As there is a correlation between the subscriber and the other subscriber, the state-based advertisement group may be considered as a group of which members have a common interest, and the same advertisement on the basis of the state information of the subscriber or the other subscriber may be provided to the state-based advertisement group.

On the other hand, the designation unit 23 may analyze another subscriber who approaches the subscriber within a threshold distance from the photographing image obtained by photographing the subscriber analysis area and, when it is determined that there is no correlation between the subscriber and the other subscriber, designate the subscriber and the other subscriber as the location-based advertisement group.

As there is a correlation between the subscriber and the other subscriber, the location-based advertisement group may be considered as a group of which members have no common interest, and the same location-based advertisement on the basis of an adjacency characteristic that is a common denominator may be provided to each subscriber within the location-based advertisement group.

Meanwhile, in connection with this, when another subscriber adjacent to the subscriber is identified from the registration image which the subscriber registers or, reversely, the subscriber is identified from the registration image which the other subscriber registers in connection with designation of the advertisement group, the designation unit 23 may determine that there is a correlation between the subscriber and the other subscriber.

The correlation can be determined in the form of a value according to a level of the correlation on the basis of an appearance frequency within the registration image as well as simply having a correlation.

Meanwhile, it has been described that each element within the service device 20 may be implemented in the form of a software module or a hardware module executed by the processor, or a combination of the software module and the hardware module.

As described above, the software module and the hardware module executed by the processor, and the combination of the software module and the hardware module may be implemented by a hardware system (for example, a computer system).

Accordingly, hereinafter, a hardware system 2000 in which the service device 20 according to an embodiment of the present disclosure is implemented in the form of hardware will be described with reference to FIG. 5.

For reference, the following description is an example of the hardware system 2000 in which each element within the subscriber terminal 10 is implemented, and it should be noted that each element and the operation thereof may be different from those of an actual system.

As illustrated in FIG. 5, the hardware system 2000 according to an embodiment of the present disclosure may include a processor unit 2100, a memory interface unit 2200, and a peripheral device interface unit 2300.

The respective elements within the hardware system 2000 may be individual elements or integrated into one or more integrated circuits, and may be combined by a bus system (not shown).

The bus system corresponds to abstraction indicating one or more individual physical buses, communication lines/interfaces, multi-drop, and/or point-to-point connections connected by proper bridges, adaptors, and/or controllers.

The processor unit 2100 may serve to execute various software modules stored in the memory unit 2210 by communicating with the memory unit 2210 through the memory interface unit 2200 in order to perform various functions in the hardware system.

The memory unit 2210 may store the identification unit 21, the analysis unit 22, the designation unit 23, and the provision unit 24 which are the elements within the service device 20 described with reference to FIG. 4 in the form of a software module and further store an Operating System (OS).

The operating system (for example, an embedded operating system such as iOS, Android, Darwin, RTXC, LINUX, UNIX, OSX, WINDOWS, or VxWorks) includes various procedures for controlling and managing general system tasks (for example, memory management, storage device control, and power management), an instruction set, a software component, and/or a driver, and serves to make communication between various hardware modules and software modules easy.

For reference, the memory unit 2210 includes a cache, a main memory, and a secondary memory but is not limited thereto, and may include a memory layer structure. The memory layer structure may be implemented through a predetermined combination of, for example, a RAM (for example, SRAM, DRAM, or DDRAM), a ROM, a FLASH, a magnetic and/or optical storage device (for example, a disk drive, a magnetic tape, a Compact Disk (CD), and a Digital Video Disc (DVD)).

The peripheral interface unit 2300 serves to enable communication between the processor unit 2100 and peripheral devices.

The peripheral device may provide different functions to the hardware system 2000 and may include, for example, a communication unit 2310 according to an embodiment of the present disclosure.

The communication unit 2310 serves to provide a communication function with another device. To this end, the communication unit 1310 may include, for example, an antenna system, an RF transceiver, one or more amplifiers, a tuner, one or more oscillators, a digital signal processor, a CODEC chipset, and a memory, but is not limited thereto, and may include a known circuit for performing the function.

Communication protocols supported by the communication unit 2310 may include, for example, Wireless LAN (WLAN), Digital Living Network Alliance (DLNA), Wireless broadband (Wibro), World interoperability for microwave access (Wimax), Global System for Mobile communication (GSM), Code Division Multi Access (CDMA), Code Division Multi Access 2000 (CDMA2000), Enhanced Voice-Data Optimized or Enhanced Voice-Data Only (EV-DO), Wideband CDMA (WCDMA), High Speed Downlink Packet Access (HSDPA), High Speed Uplink Packet Access (HSUPA), IEEE 802.16, Long Term Evolution (LTE), Long Term Evolution-Advanced (LTE-A), Wireless Mobile Broadband Service (WMBS), Bluetooth, Radio Frequency Identification (RFID), Infrared Data Association (IrDA), Ultra-Wideband (UWB), ZigBee, Near Field Communication (NFC), Ultra Sound Communication (USC), Visible Light Communication (VLC), Wi-Fi, and Wi-Fi Direct. Wired communication networks may include wired Local Area Network (LAN), wired Wide Area Network (WAN), Power Line Communication (PLC), USB communication, Ethernet, serial communication, and optical fiber/coaxial cable, but are not limited thereto and may include nay protocol that can provide a communication environment with another device.

As a result, each element within the service device 20 stored in the memory unit 2210 of the hardware system 2000 according to an embodiment of the present disclosure in the form of a software module may execute an interface with the communication unit 2310 via the memory interface unit 2200 and the peripheral device interface unit 2300 in the form of instructions executed by the processor unit 2100, thereby providing a targeted advertisement suitable for the state information of the subscriber analyzed from the photographing image obtained by photographing the subscriber analysis area.

As described above, according to the targeted advertisement system according to an embodiment of the present disclosure and each element within the system, it is possible to analyze state information of the subscriber from the photographing image and provide an advertisement on the basis of the analyzed state information, thereby providing a target advertisement reflecting a real-time state of the subscriber so as to increase an advertisement effect.

Hereinafter, an operation flow in the targeted advertisement system according to an embodiment of the present disclosure will be described.

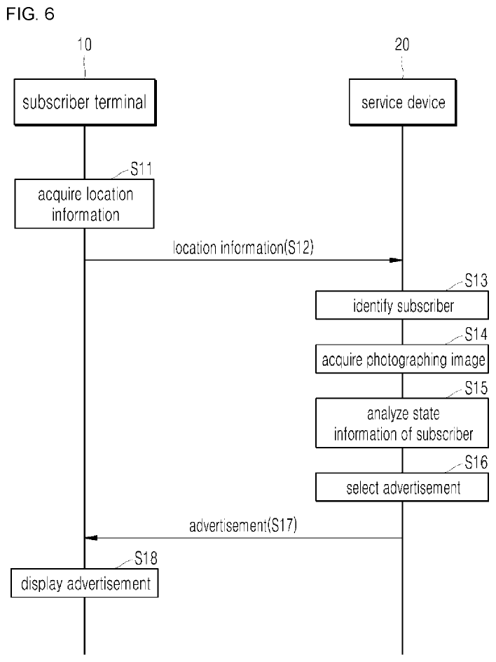

In connection with this, FIG. 6 illustrates an operation flow in the targeted advertisement system according to an embodiment of the present disclosure.

First, the subscriber terminal 10 acquires location information and transfers the location information to the service device 20 in S11.

At this time, the subscriber terminal 10 may acquire location information according to a period configured in an application or a request from the service device 20 and transmit the location information to the service device 20.

Here, the location information may include, for example, AP access information and GPS information, and may be transferred to the service device 20 together with visual information of the acquired location information while matching identification information (a subscriber ID) of the subscriber terminal 10.

In connection with this, the service device 20 identifies a subscriber located in a predefined subscriber analysis area based on the location information received from the subscriber terminal 10 in S12.

The subscriber analysis area is a heavily populated area and corresponds to an area in which a photographing image (for example, a video or a photo) obtained by photographing the corresponding area through a photographing device such as a CCTV can be always acquired.

Then, when the subscriber located in the subscriber analysis area is identified, the service device 20 may analyze state information of the subscriber based on a photographing image obtained by photographing the subscriber analysis area and select an advertisement targeted at the subscriber based on the analyzed state information in S13 to S16.

For example, when it is identified that the subscriber does not have an umbrella based on the state information of the subscriber analyzed from the photographing image and when it is raining, an advertisement about an umbrella store closest to the subscriber in the subscriber analysis area may be selected.

In other words, when it is identified that the subscriber is located in the subscriber analysis area based on the location information of the subscriber terminal 10, the service device 20 may acquire the photographing image from the corresponding subscriber analysis area and derive state information of the subscriber by analyzing the acquired photographing image.

The state information of the subscriber may include information on a precise location of the subscriber within the subscriber analysis area, and clothes and belongings of the subscriber but is not limited thereto and may include any general information which can be acquired from the image according to a known image analysis technology.

The state information of the subscriber may be analyzed through the known image analysis technology as described above, but, in an embodiment of the present disclosure, state information of a particular object having similarity with a reference object image for recognizing the subscriber among objects within the photographing image is basically analyzed as the state information of the subscriber, the similarity being larger than or equal to a threshold value.

In order to analyze the state information of the subscriber, it is required to prepare the reference object image to be compared with the object within the photographing image, and the reference object image may be learned from a registration image pre-registered in connection with the subscriber.

The registration image may be understood as, for example, an image (for example, a moving image or a photo) uploaded to a subscriber's account in a specific Social Network Service (SNS) associated with the service device 20, but is not limited thereto and may also include an image which the subscriber directly registers in the service device 20.

Thereafter, the subscriber terminal 10 displays the advertisement received from the service device 20 to the subscriber in S17 to S18.

The description for the operation flow in the targeted advertisement system according to an embodiment of the present disclosure has been completed and the description of the operation flow in the subscriber terminal 10 will be subsequently made.

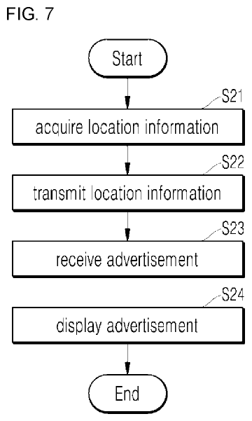

In connection with this, FIG. 7 illustrates the operation flow in the subscriber terminal 10 according to an embodiment of the present disclosure.

First, the transmitter 11 acquires location information of the subscriber terminal 10 and transfers the location information to the service device 20 in S21 to S22.

At this time, the transmitter 11 may acquire location information according to a period configured in an application or a request from the service device 20 and transmit the location information to the service device 20.

Here, the location information may include, for example, AP access information and GPS information, and may be transferred to the service device 20 together with visual information of the acquired location information while matching identification information (a subscriber ID) of the subscriber terminal 10.

Thereafter, the advertisement unit 12 receives an advertisement targeted at the subscriber from the service device 20 based on the location information of the subscriber terminal 10 and displays the advertisement in S23 to S24.

In connection with this, the service device 20 may identify the subscriber located in a predefined subscriber analysis area based on the location information received from the subscriber terminal 10, analyze a state information of the subscriber based on a photographing image which is obtained by photographing the subscriber analysis area, and provide an advertisement on the basis of the analyzed state information to the subscriber terminal 10.

In connection with this, a case in which an advertisement about an umbrella store closest to the subscriber in the subscriber analysis area is provided when it is identified that the subscriber does not have an umbrella based on the state information of the subscriber analyzed from the photographing image and when it is raining is provided as an example.

The subscriber analysis area is a heavily populated area and corresponds to an area in which a photographing image (for example, a video or a photo) obtained by photographing the corresponding area through a photographing device such as a CCTV can be always acquired.

Further, the state information may include information on a precise location of the subscriber within the subscriber analysis area, and clothes and belongings of the subscriber but is not limited thereto and may include any general information which can be acquired from the image according to a known image analysis technology.

That is, when it is identified that the subscriber is positioned in the subscriber analysis area based on the location information of the subscriber terminal 10, the service device 20 may acquire a photographing image from the corresponding subscriber analysis area and analysis the state information of the subscriber by analyzing the acquired photographing image.

The state information of the subscriber may be analyzed through the known image analysis technology as described above, but, in an embodiment of the present disclosure, state information of a particular object having similarity with a reference object image for recognizing the subscriber among objects within the photographing image is analyzed as the state information of the subscriber, the similarity being larger than or equal to a threshold value.

In order to analyze the state information of the subscriber, it is required to prepare the reference object image to be compared with the object within the photographing image, and the reference object image may be learned from a registration image pre-registered in connection with the subscriber.

The registration image may be understood as, for example, an image (for example, a moving image or a photo) uploaded to a subscriber's account in a specific Social Network Service (SNS) associated with the service device 20, but is not limited thereto and may also include an image which the subscriber directly registers in the service device 20.

The description for the operation flow in the subscriber terminal 10 according to an embodiment of the present disclosure has been completed, and the description for the operation flow in the service device 20 will be subsequently made.

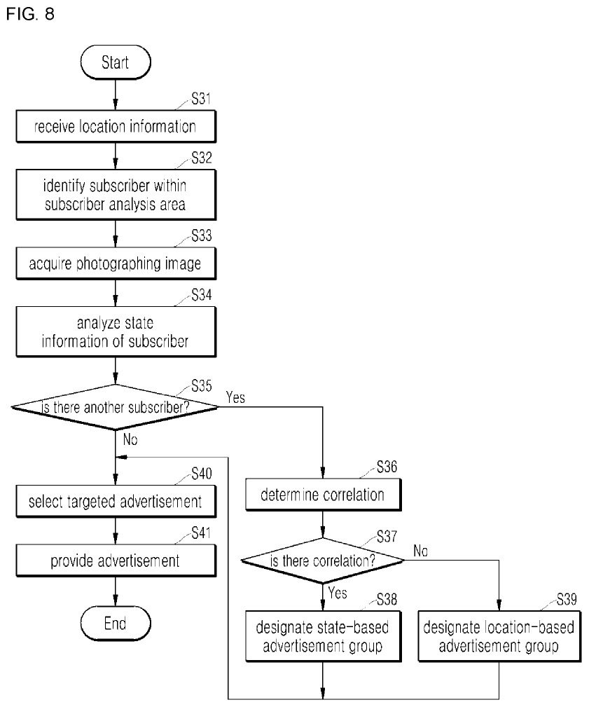

In connection with this, FIG. 8 illustrates the operation flow in the service device 20 according to an embodiment of the present disclosure.

First, the identification unit 21 identifies a subscriber located in a predefined subscriber analysis area based on location information received from the subscriber terminal 10 in S31 to S32.

The subscriber analysis area is a heavily populated area and corresponds to an area in which a photographing image (for example, a video or a photo) obtained by photographing the corresponding area through a photographing device such as a CCTV can be always acquired.

Then, when the subscriber located in the subscriber analysis area is identified, the analysis unit 22 analyzes state information of the subscriber based on a photographing image obtained by photographing the subscriber analysis area in S33 to S34.

That is, when it is identified that the subscriber is located in the subscriber analysis area based on the location information of the subscriber terminal 10, the analysis unit 22 may acquire the photographing image from the corresponding subscriber analysis area and analyze state information of the subscriber by analyzing the acquired photographing image.

The state information of the subscriber may include information on a precise location of the subscriber within the subscriber analysis area, and clothes and belongings of the subscriber but is not limited thereto and may include any general information which can be acquired from the image according to a known image analysis technology.

The state information of the subscriber may be analyzed through the known image analysis technology as described above, but, in an embodiment of the present disclosure, state information of a particular object having similarity with a reference object image for recognizing the subscriber among objects within the photographing image is basically analyzed as the state information of the subscriber, the similarity being larger than or equal to a threshold value.

In order to analyze the state information of the subscriber, it is required to prepare the reference object image to be compared with the object within the photographing image, and the reference object image may be learned from a registration image pre-registered in connection with the subscriber.

The registration image may be understood as, for example, an image (for example, a moving image or a photo) uploaded to a subscriber's account in a specific Social Network Service (SNS) associated with the service device 20, but is not limited thereto and may also include an image which the subscriber directly registers in the service device 20.

Thereafter, in connection with this, when the state information of the subscriber is analyzed, the provision unit 24 provides a targeted advertisement selected based on the analyzed state information of the subscriber to the subscriber terminal 10 in S40 to S41.

For example, when it is identified that the subscriber does not have an umbrella based on the state information of the subscriber analyzed from the photographing image and when it is raining, an advertisement about an umbrella store closest to the subscriber in the subscriber analysis area may be provided.

Meanwhile, when another subscriber who approaches the subscriber within a threshold distance is analyzed based on the photographing image obtained by photographing the subscriber analysis area according to the analysis result in step S34, the designation unit 23 designates the subscriber and the other subscriber as an advertisement group in S35 to S39.

At this time, the designation unit 23 may determine whether there is a correlation between the subscriber and the other subscriber prior to designation of the advertisement group and may classify the subscriber and the other subscriber as a state-based advertisement group or a location-based advertisement group according to the determination result.

That is, the designation unit 23 may analyze another subscriber who approaches the subscriber within a threshold distance from the photographing image obtained by photographing the subscriber analysis area and, when it is determined that there is a correlation between the subscriber and the other subscriber, designate the subscriber and the other subscriber as the state-based advertisement group.

As there is a correlation between the subscriber and the other subscriber, the state-based advertisement group may be considered as a group of which members have a common interest, and the same advertisement on the basis of the state information of the subscriber or the other subscriber may be provided to the state-based advertisement group.

On the other hand, the designation unit 23 may analyze another subscriber who approaches the subscriber within a threshold distance from the photographing image obtained by photographing the subscriber analysis area and, when it is determined that there is no correlation between the subscriber and the other subscriber, designate the subscriber and the other subscriber as the location-based advertisement group.

As there is a correlation between the subscriber and the other subscriber, the location-based advertisement group may be considered as a group of which members have no common interest, and the same location-based advertisement on the basis of an adjacency characteristic that is a common denominator may be provided to the location-based advertisement group.

Meanwhile, in connection with this, when another subscriber adjacent to the subscriber is identified from the registration image which the subscriber registers or, reversely, the subscriber is identified from the registration image which the other subscriber registers in connection with designation of the advertisement group, the designation unit 23 may determine that there is a correlation between the subscriber and the other subscriber.

The correlation can be determined in the form of a value according to a level of the correlation on the basis of an appearance frequency within the registration image as well as simply having a correlation.

As described above, according to the targeted advertisement system according to an embodiment of the present disclosure and an operation method of each element within the system, it is possible to analyze state information of the subscriber from the photographing image and provide an advertisement on the basis of the analyzed state information to the subscriber, thereby providing a target advertisement reflecting a real-time state of the subscriber so as to increase an advertisement effect.

The implementations of the functional operations and subject matter described in the present disclosure may be realized by a digital electronic circuit, by the structure described in the present disclosure, and the equivalent including computer software, firmware, or hardware including, or by a combination of one or more thereof. Implementations of the subject matter described in the specification may be implemented in one or more computer program products, that is, one or more modules related to a computer program command encoded on a tangible program storage medium to control an operation of a processing system or the execution by the operation.

A computer-readable medium may be a machine-readable storage device, a machine-readable storage substrate, a memory device, a composition of materials influencing a machine-readable radio wave signal, or a combination of one or more thereof.

In the specification, the terms “system” and “device”, for example, cover a programmable processor, a computer, or all kinds of mechanisms, devices, and machines for data processing, including a multiprocessor and a computer. The processing system may include, in addition to hardware, a code that creates an execution environment for a computer program when requested, such as a code that constitutes processor firmware, a protocol stack, a database management system, an operating system, or a combination of one or more thereof.

A computer program (also known as a program, software, software application, script, or code) can be written in any form of programming language, including compiled or interpreted languages, declarative or procedural languages, and it can be deployed in any form, including as a stand-alone program or module, a component, subroutine, or another unit suitable for use in a computer environment. A computer program may, but need not, correspond to a file in a file system. A program can be stored in a single file provided to the requested program, in multiple coordinated files (for example, files that store one or more modules, sub-programs, or portions of code), or in a portion of a file that holds other programs or data (for example, one or more scripts stored in a markup language document). A computer program can be deployed to be executed on one computer or on multiple computers that are located at one site or distributed across a plurality of sites and interconnected by a communication network.

A computer-readable medium suitable for storing a computer program command and data includes all types of non-volatile memories, media, and memory devices, for example, a semiconductor memory device such as an EPROM, an EEPROM, and a flash memory device, and a magnetic disk such as an external hard disk or an external disk, a magneto-optical disk, a CD-ROM, and a DVD-ROM disk. A processor and a memory may be added by a special purpose logic circuit or integrated into the logic circuit.

The implementations of the subject matter described in the specification may be implemented in a calculation system including a back-end component such as a data server, a middleware component such as an application server, a front-end component such as a client computer having a web browser or a graphic user interface which can interact with the implementations of the subject matter described in the specification by the user, or all combinations of one or more of the back-end, middleware, and front-end components. The components of the system can be mutually connected by any type of digital data communication such as a communication network or a medium.

While the specification contains many specific implementation details, these should not be construed as limitations to the scope of any disclosure or of what may be claimed, but rather as descriptions of features that may be specific to particular embodiments of particular disclosures. Certain features that are described in the specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

In addition, in the specification, the operations are illustrated in a specific sequence in the drawings, but it should be understood that the operations are not necessarily performed in the shown specific sequence or that all shown operations are necessarily performed in order to obtain a preferable result. In a specific case, multitasking and parallel processing may be preferable. Furthermore, it should not be understood that a separation of the various system components of the above-mentioned implementation is required in all implementations. In addition, it should be understood that the described program components and systems usually may be integrated in a single software package or may be packaged in a multi-software product.

As described above, specific terms disclosed in the specification do not intend to limit the present disclosure. Therefore, while the present disclosure was described in detail with reference to the above-mentioned examples, a person skilled in the art may modify, change, and transform some parts without departing a scope of the present disclosure. The scope of the present disclosure is defined by the appended claims to be described later, rather than the detailed description. Accordingly, it will be appreciated that all modifications or variations derived from the meaning and scope of the appended claims and their equivalents are included in the range of the present disclosure.

What is claimed is:

1. A service device comprising:
a processor configured to perform calculations for providing an advertisement; and
a memory configured to store at least one command executed through the processor,
wherein the at least one command comprises:
an identification command of identifying a subscriber located in a subscriber analysis area based on location information of a subscriber terminal; and
an analysis command of analyzing state information of the subscriber based on a photographing image obtained by photographing the subscriber analysis area and providing an advertisement according to the analyzed state information to the subscriber.

2. The service device of claim 1, wherein the at least one command further comprises a designation command of analyzing other subscriber who approaches the subscriber within a threshold distance based on the photographing image, designating the subscriber and the other subscriber as a state-based advertisement group when it is determined that there is a correlation between the subscriber and the other subscriber, and providing an identical advertisement on the basis of state information of at least one of the subscriber and the other subscriber to the subscriber within the state-based advertisement group.

3. The service device of claim 1, wherein the at least one command further comprises a designation command of analyzing other subscriber who approaches the subscriber within a threshold distance based on the photographing image, designating the subscriber and the other subscriber as a location-based advertisement group when it is determined that there is no correlation between the subscriber and the other subscriber, and providing an identical advertisement on the basis of the location to the subscriber within the location-based advertisement group.

4. The service device of claim 2, wherein, when the other subscriber is identified from a registration image which the subscriber registers or the subscriber is identified from a registration image which the other subscriber registers, the designation command comprises determining that there is a correlation between the subscriber and the other subscriber.

5. The service device of claim 1, wherein the analysis command comprises identifying a particular object having similarity with a reference object image for recognizing the subscriber from objects within the photographing image and analyzing state information of the particular object as the state information of the subscriber.

6. The service device of claim 5, wherein the reference object image is learned from a registration image pre-registered in connection with the subscriber and the registration image includes an image uploaded to a particular Social Network Service (SNS) of the subscriber.

7. A method of operating a service device, the method comprising:
identifying a subscriber located in a subscriber analysis area based on location information of a subscriber terminal; and
analyzing state information of the subscriber based on a photographing image obtained by photographing the subscriber analysis area and providing an advertisement according to the analyzed state information to the subscriber.

8. The method of claim 7, further comprising a designation step of analyzing other subscriber who approaches the subscriber within a threshold distance based on the photographing image, designating the subscriber and the other subscriber as a state-based advertisement group when it is determined that there is a correlation between the subscriber and the other subscriber, and providing an identical advertisement on the basis of state information of at least one of the subscriber and the other subscriber to the subscriber within the state-based advertisement group.

9. The method of claim 7, further comprising a designation step of analyzing other subscriber who approaches the subscriber within a threshold distance based on the photographing image, designating the subscriber and the other subscriber as a location-based advertisement group when it is determined that there is no correlation between the subscriber and the other subscriber, and providing an identical advertisement on the basis of the location to the subscriber within the location-based advertisement group.

10. The method of claim 8, wherein the designation step comprises, when the other subscriber is identified from a registration image which the subscriber registers or the subscriber is identified from a registration image which the other subscriber registers, determining that there is a correlation between the subscriber and the other subscriber.

11. The method of claim 7, wherein the analysis step comprises identifying a particular object having similarity with a reference object image for recognizing the subscriber from objects within the photographing image and analyzing state information of the particular object as the state information of the subscriber.

12. The method of claim 11, wherein the reference object image is learned from a registration image pre-registered in connection with the subscriber and the registration image includes an image uploaded to a particular Social Network Service (SNS) of the subscriber.
